(19) United States
(12) Patent Application Publication
(10) Pub. No.: US 2025/0156871 A1
(43) Pub. Date: May 15, 2025

(54) TASK-GUIDED GRAPH AUGMENTATION AND EDITING FOR NODE CLASSIFICATION AND FRAUD DETECTION

(71) Applicants: INTERNATIONAL BUSINESS MACHINES CORPORATION, ARMONK, NY (US); MASSACHUSETTS INSTITUTE OF TECHNOLOGY, CAMBRIDGE, MA (US)

(72) Inventors: Yada Zhu, Irvington, NY (US); Xiaojie Guo, Burke, VA (US); David Cox, Somerville, MA (US); Shuaicheng Zhang, Blacksburg, VA (US)

(21) Appl. No.: 18/507,044

(22) Filed: Nov. 11, 2023

(51) Int. Cl. G06Q 20/40

(52) U.S. Cl. CPC G06Q 20/4016

(57) ABSTRACT

A computer-implemented method for task-guided graph augmentation and editing includes receiving an input graph in an observed financial transaction network. A data augmentation function is learned, where the data augmentation function maintains a true data distribution of the input graph. An augmented financial transaction network is generated that enhances performance of a downstream task and preserves topological and temporal properties of the input graph.

### BACKGROUND

The present disclosure generally relates to systems and methods for graph node classification, and more particularly, to a task-guided graph augmentation and editing method that can provide node classification and fraud detection.

Graph mining is a power method to discover and characterize patterns of interests from financial transactions networks. Such patterns can be used in various fields, such as anti-money laundering, credit card fraud, identity protection, product promotion, and service promotion. However, state-of-the-art graph mining algorithms often suffer from high generalization errors due to data sparsity, data noisiness, and data dynamics. Ensuring accuracy and robustness in such evolving systems is of paramount importance.

The financial transaction network provides a powerful data model to represent and organize massive financial transactions. It is fundamental for financial institutions to understand the underlying transaction patterns motivated by high-stakes applications, such as anti-money laundering, identity protection, product promotion, service promotion, and the like. In the past decades, a wealth of theories, algorithms, and open-source systems have been developed to mine the patterns of interest on financial transaction networks. Despite the tremendous success, the performance of temporal graph mining approaches on financial transaction networks often suffers from high generalization errors, which are mainly constituted by the following three factors: (1) data sparsity, where real-world financial transaction networks are naturally sparse, i.e., the transaction records at a certain timestamp only occur among a relatively small subset of entities, compared with the massive transaction network; (2) data noisiness, where the intricate process of data extraction and cleaning for these financial transaction networks can inadvertently introduce uncertainties. This uncertainty reflected in the constructed financial transaction networks can lead to redundant, missing, or even incorrect features and structures; and (3) data dynamics, where realistic financial transactions are evolving in continuous time with multiple resolutions (e.g., seconds, minutes, hours, and days), whereas existing work often represent it as temporal graph snapshots with a certain resolution. In addition to these challenges, financial transaction networks often include sensitive data, limiting the direct utilization of features like transaction amounts.

### SUMMARY

In one embodiment, a system and method are described that provide a fundamental transition from traditional mining to augmentation in the context of financial transaction networks. To navigate this paradigm shift, a versatile task-guided temporal graph augmentation framework, referred to as TGEditor, can concurrently preserve the temporal and topological distribution of input financial transaction networks, whilst leveraging the label information from pertinent downstream tasks. In particular, given a task T on a financial transaction network G, the system and methods of the present disclosure determines how to improve the performance of T by editing the local structure of G, while well preserving the structural and temporal distribution of G. TGEditor, a generic task-guided financial transaction network augmentation framework can provide a task-guided context extractor that extracts network contextual information by preserving the graph evolution process of financial transaction networks conditioned on a specific task T. TGEditor can also provide a multi-resolution temporal generative model which jointly learns and infers from the financial transaction network's multi-resolution temporal properties and topological properties. Finally, TGEditor can also provide a financial transaction editor which performs task-specific data augmentation via two network editing operators that can be seamlessly optimized via adversarial training, while simultaneously capturing the dynamics of the data: (1) an add operator aims to recover the missing temporal links due to data sparsity, and (2) the prune operator is formulated to remove irrelevant/noisy temporal links due to data noisiness. Extensive results on financial transaction networks demonstrate that TGEditor (1) well preserves the data distribution of the original graph, and (2) notably boosts the performance of the prediction models in the tasks of vertex classification and fraudulent transaction detection.

In one embodiment, a computer implemented method and a computer program product can be configured for task-guided graph augmentation and editing. The method includes receiving an input graph in an observed financial transaction network and learning a data augmentation function that maintains a true data distribution of the input graph. An augmented financial transaction network is generated that enhances performance of a downstream task and preserves topological and temporal properties of the input graph.

In another embodiment, a system includes a processor, a data bus coupled to the processor, a memory coupled to the data bus, and a computer-usable medium embodying a computer program code. The computer program code include instructions executable by the processor. The instructions are configured to receive an input graph in an observed financial transaction network and learn a data augmentation function that maintains a true data distribution of the input graph. An augmented financial transaction network is generated that enhances performance of a downstream task and preserves topological and temporal properties of the input graph.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a pictorial representation of components of a system for task-guided graph augmentation and editing, consistent with an illustrative embodiment;

FIG. 2 shows a flow chart illustrating a method for task-guided graph augmentation and editing, consistent with an illustrative embodiment;

FIGS. 3A through 3D show transactions as directed links in a temporal graph;

FIG. 3E shows an exemplary sampled temporal random walk made by the multi-resolution temporal generative model of FIG. 1;

FIG. 4 shows an exemplary operation of a task-guided context extractor used in the system of FIG. 1;

FIG. 5 shows an iterative visualization of temporal random walk (TRW) generation through the multi-resolution temporal generative model of the system of FIG. 1;

FIGS. 6A and 6B show tables of results comparing the methods of the present disclosure with conventional fraudulent transaction identification models;

FIG. 7 illustrates evaluation metrics in comparing the methods of the present disclosure with conventional fraudulent transaction identification models;

FIG. 8 shows a flow chart illustrating an overall process for task-guided graph augmentation and editing, consistent with an illustrative embodiment; and

FIG. 9 is a functional block diagram illustration of a computer hardware platform that can be used to implement the method for task-guided graph augmentation and editing, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As used herein, the term, “Financial Transaction Network”, designated G, where G=(V, ε) consists of a set of vertices (clients) V={v₁, v₂, . . . } and a series of timestamped edges (transactions) ε. Each transaction eᵢ connects two vertices and is associated with a timestamp denoted by tₑᵢ.

As used herein, the term “Temporal Random Walk” refers to a series of connected temporal edges {e₁^{t}^{ₑᵢ}, e₂^{t}^{ₑ₂}, . . . eₗ^{t}^{ₑₗ}} sampled from G following temporal constraints (i.e., tₑᵢ≤tₑᵢ₊₁), tₑᵢ+1 where l is the walk length and eᵢ^{t}^{ₑᵢ} is directly connected to eᵢ₊₁^{t}^{ₑᵢ₊₁}.

As used herein, the term “Temporal Graph Neighborhood” refers to, given a temporal vertex vᵢ, the spatial and temporal neighborhood N associated with it is defined as N={vᵢ^{t}^{ᵥᵢ} | Dₛₚₐ (vᵢ^{t}^{ᵥᵢ}, vⱼ^{t}^{ᵥⱼ})≤dₛₚₐ, Dₜₑₘ(tᵥᵢ, tᵥⱼ)≤dₜₑₘ}, where Dₛₚₐ(vᵢ, vⱼ) indicates the spatial distance (shortest path) from vertex vᵢ to vⱼ and i≠j, Dₜₑₘ(tᵥᵢ, tᵥⱼ) indicates the temporal distance from time stamp tᵥᵢ to tᵥⱼ, and dₛₚₐ and dₜₑₘ are user-defined spatial distance and temporal distance thresholds, respectively.

As described in greater detail below, aspects of the present disclosure provide systems and methods that can learn the temporal and structure distribution of input graphs and leverage the label information from downstream tasks T to conduct task-guided data augmentation for financial transaction networks.

According to an aspect of the present disclosure, there is provided a computer-implemented method, a system and a computer program product for task-guided graph augmentation and editing, where the method includes receiving an input graph in an observed financial transaction network and learning a data augmentation function that maintains a true data distribution of the input graph. An augmented financial transaction network is generated that enhances performance of a downstream task and preserves topological and temporal properties of the input graph.

In an embodiment, which can be combined with the preceding embodiment, the method further includes determining, via adversarial training, an add operator operable to add additional links to the input graph.

In an embodiment, which can be combined with one or more of the preceding embodiments, the method further includes determining, via adversarial training, a prune operator operable to remove selected links from the input graph.

In an embodiment, which can be combined with one or more of the preceding embodiments, the method further includes extracting network contextual information from the input graph with a task-guided context extractor by sampling a set of temporal random walk sequences conditioned on a specific task.

In an embodiment, which can be combined with one or more of the preceding embodiments, the method further includes learning and inferring, from multi-resolution temporal properties and topological properties of the input graph, to generate a multi-resolution temporal generative model for generating the data augmentation function.

In an embodiment, which can be combined with one or more of the preceding embodiments, the method further includes training the multi-resolution temporal generative model with the set of temporal random walk sequences generated by the task-guided context extractor.

In an embodiment, which can be combined with one or more of the preceding embodiments, the multi-resolution temporal generative model includes a generator operable to generate temporal random walk samples from a given class to explicitly capture temporal and topological properties from the given class.

In an embodiment, which can be combined with one or more of the preceding embodiments, the multi-resolution temporal generative model includes a discriminator operable to output a logit indicating a probability of generated temporal random walk samples being sampled from the input graph.

In an embodiment, which can be combined with one or more of the preceding embodiments, the method further includes preventing overediting by removing an edited sequence from the augmented financial transaction network if the edited sequence does not preserve network properties of the input graph.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may learn the temporal and structure distribution of input graphs and leverage the label information from downstream tasks to conduct task-guided data augmentation for financial transaction networks. This may have the technical effect of accurately predicting patterns of interest from financial transactions networks, such as anti-money laundering, credit card fraud, identity protection, and network risks. Accordingly, the system and methods according to aspects of the present disclosure provide a substantial improvement to technology and computer functionality.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

Aspects of the present disclosure can consider a financial transaction network with a limited number of labeled transactions from |C| classes, where the classes are determined by the downstream task. Without loss of generality, the labeled set for the downstream tasks T is denoted as L={v₁, v₂, . . . v|_{L}|}. Aspect of the present disclosure can utilize this label information to modify a sparse graph by adding “missing” links and removing “noisy” links. By augmenting the provided financial transaction network (e.g., by adding missing links or removing noisy links), patterns of interest (e.g., fraudulent transactions) become more pronounced, thereby facilitating their identification by machine learning (ML) models.

Accordingly, aspects of the present disclosure can learn a data augmentation function Ge that maintains the true data distribution, enabling the filling in of the missing links and the elimination of the noisy links in the observed financial transaction network G. For example, given (1) an observed directed financial transaction network G={V, ε}, and (2) task-specific vertex labels or edge labels, aspects of the present disclosure can find the structurally augmented temporal graph G that (1) enhances performance on downstream task T (i.e., node classifications and fraudulent transaction prediction), (2) preserves the topological and temporal properties of the input temporal graph G, and (3) is consistent with the label information.

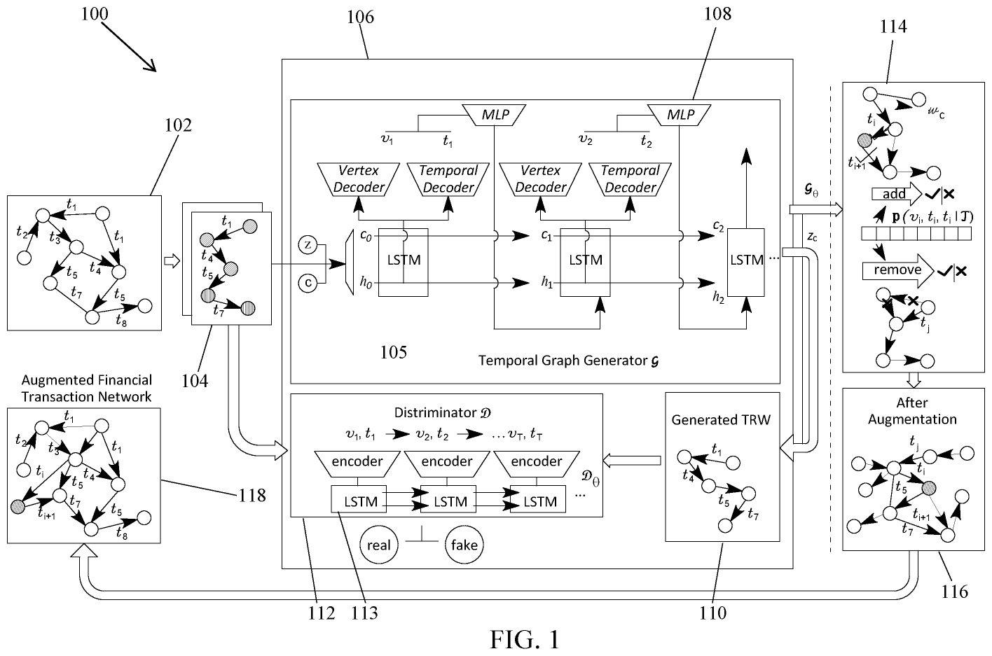

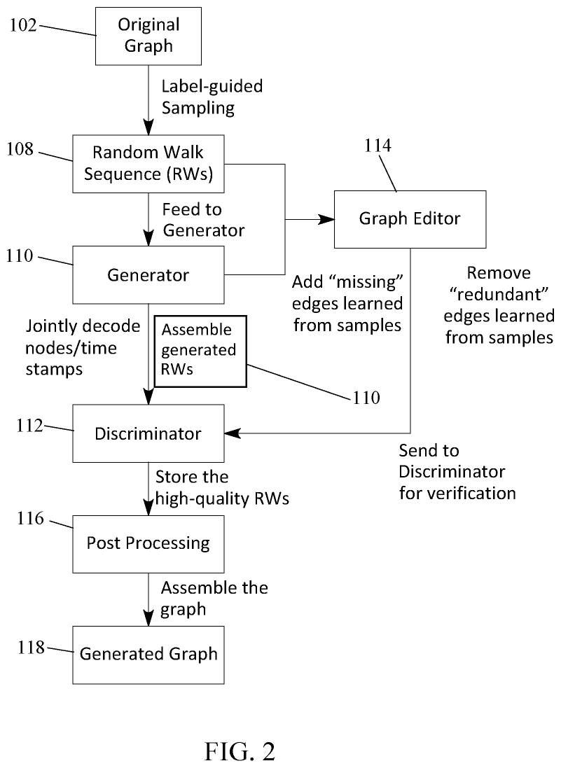

An overview of a proposed TGEditor framework 100 is presented in FIGS. 1 and 2, which includes three modules: a task-guided context extractor 104 (also referred to simply as context extractor 104), a multi-resolution temporal generative model 106, and a financial transaction editor 114. Given a financial transaction network 102, the context extractor 104 first extracts task-guided network contextual information of financial transaction networks by sampling a set of TRW sequences Wc conditioned on a specific task T. In the multi-resolution temporal generation model 106, a multi-resolution context generative model is developed which includes a TRW generator 108, 110 and a TRW discriminator 112 to approximate the joint topological and temporal distribution of G, i.e., p(v^{tv} | G, T).

In the multi-resolution temporal general model 106, important task-guided contextual information is learned from the extracted task-specific TRW sequences Wc in the context extractor 104. In the financial transaction editor 114, a financial transaction editor is provided to augment G by proposing a handful of editions, including Add, which aims to recover the missing temporal links due to data sparsity, and Prune, which is formulated to remove irrelevant/noisy temporal links due to data noisiness.

In the field of graph-based data augmentation, conventional methods have primarily been unsupervised, utilizing pre-established augmentation techniques such as structural perturbation and graph diffusion (e.g., structural-wise perturbation and graph diffusion, contrastive learning). However, these unsupervised approaches may not guarantee optimal performance in downstream tasks, particularly when label information is available. For instance, in the context of financial fraud detection, it is commonly observed that fraudsters are rare and skilled at evading detection systems. As a result, unsupervised data augmentation methods may not effectively emphasize fraudulent patterns without supervision. Furthermore, improper data augmentation may introduce artificial biases and degrade overall performance. Motivated by these considerations, aspects of the present disclosure provide a task-guided context extractor 104 that leverages both the input data G and the label information L from the downstream tasks T to achieve improved performance. Given a financial transaction network G with a label set L from the downstream task T, the context extractor 104 aims to extract task-specific contextual information to train the multi-resolution temporal generative model 106. Technique of Temporal Random Walks (TRW) is utilized as a tool for sampling and extracting contextual information, such as neighborhood topology and temporal properties, from the given financial transaction network.

A straightforward approach to capture task-specific contextual information would be to conduct TRWs starting from each labeled vertex in L. However, the label set may include both representative and boundary examples, such as examples located at the center versus the boundary of the support region of a class. To effectively capture task-specific contextual information, it is salient to understand the task-specific contextual importance of each vertex in the labeled set L.

Aspects of the present disclosure quantify the task-specific contextual importance of each vertex v^{tv} in the labeled set L through the following conditional probability:

$$\begin{matrix}p ( {v}^{t v} \vert G , T ) = p ( {v}^{t v} \vert N ( {v}^{t v} ) , T ) \\ = p ( {v}^{t v} \vert {N}_{s p a} ( {v}^{t v} ) , {N}_{t e m} ( {v}^{t v} ) , T )\end{matrix} \qquad ( 1 )$$

where Nₛₚₐ (v^{tv})={vᵢ^{t}^{ᵥᵢ} | Dₛₚₐ(vᵢ^{t}^{ᵥᵢ}, v^{t}^{ᵥⱼ})≤dₛₚₐ) and Nₜₑₘ(v^{t}^{ᵥ})=vᵢ^{t}^{ᵥᵢ} | Dₜₑₘ(tᵥᵢ, tᵥⱼ)≤dₜₑₘ} are the sets of spatial and temporal neighbors of vₜᵥ, respectively. Intuitively, a high p(v^{tv} |G, T) score indicates that v^{tv} is a representative vertex for T and can serve as a suitable starting point for extracting task-specific context via TRWs. Conversely, a low p(v^{tv} |G, T) score suggests that v^{tv}'s neighborhood may not preserve the desired task-specific contextual information. However, computing p(v^{tv} | Nₛₚₐ (v^{tv}), Nₜₑₘ(v^{tv}), T) is challenging due to the uncertainty in the dependency between Nₛₚₐ(v^{tv}) and Nₜₑₘ(v^{tv}).

The results can indicate a weak relationship between spatial distribution and temporal distribution in realistic temporal networks, where vertices with high degrees tend to be active in future timestamps, while those with low degrees tend to be inactive. Specifically, clients who are highly active in making transactions are more likely to continue doing so in the future, whereas clients who are less active in making transactions are less likely to do so in the future. Aspects of the present disclosure make the assumption that the task-specific topological distribution p(v^{tv} | Nₛₚₐ(v^{tv}), T) and the task-specific temporal distribution p(v^{tv} | Nₜₑₘ(v^{tv}), T) follow a weakly independent relationship.

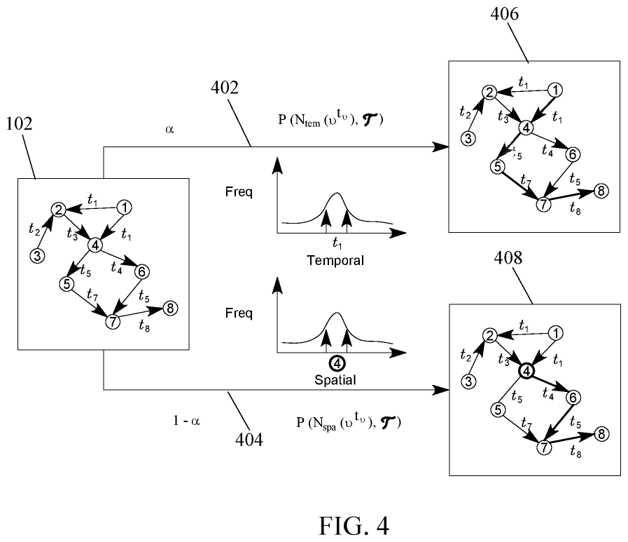

With that, for δ>0,

$$p ( {v}^{t v} \vert {N}_{t e m} ( {v}^{t v} ) , {N}_{s p a} ( {v}^{t v} ) , T ) \geq δ [ p ( {v}^{t v} \vert {N}_{t e m} ( {v}^{t v} ) , T ) \times p ( {v}^{t v} \vert {N}_{s p a} ( {v}^{t v} ) , T ) ]$$

where p(v^{tv} | Nₛₚₐ(v^{tv}), T) and p(v^{tv} | Nₜₑₘ(v^{tv}), T) can be easily approximated via existing heuristic functions. Based on the above equation, aspects of the present disclosure provide a novel contextual sampling strategy. For each class c in T, a collection of TRWs are sampled with the length of T as Wc={w₁ . . . w_{|W}_{_{c}}_{|} c∈T}. With probability of α∈[0, 1], temporal-guided graph context is sampled from vertices with high p(v^{tv} | Nₜₑₘ v^{tv}), T). With probability 1−α, spatial-guided graph context is sampled from vertices with high p(v^{tv} | Nₛₚₐ(v^{tv}), T). By sampling representative vertices from both distributions, aspects of the present disclosure can maximally capture topological and temporal properties for the given class c from G. In FIG. 4, an illustrative example is shown of how to jointly extract temporal and spatial neighborhood contextual information. With probability α, as shown in path 402, the context extractor samples a TRW starting from one of the vertices associated with high temporal frequency. In the graph 406, this vertex one, where the TRW is from 1 to 4 to 5 to 7 to 8, as illustrated by the bold arrows in graph 406. With probability 1−α, as shown in path 404, the context extractor samples a TRW starting from one of the vertices associated with high spatial frequency. In the graph 408, this vertex four, where the TRW is from 4 to 6 to 7 to 8, as illustrated by the bold arrows in graph 408.

After selecting corresponding class representative vertices, label-informed TRW samplers are used to extract TRWs from each class, which will be fed into the multi-resolution temporal generative model 106 for training purposes.

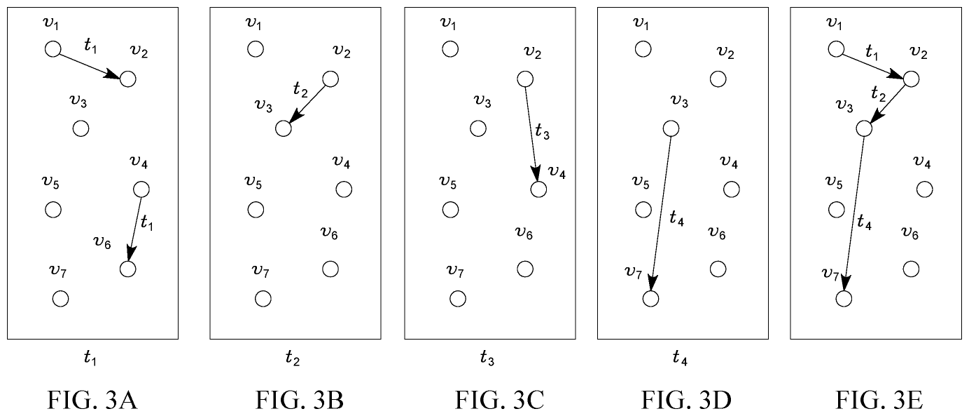

Through the context extractor 104, task-guided temporal random walks (TRW) Wc are extracted that preserve the temporal and topological properties of the financial transaction network and the label information from downstream tasks T. FIGS. 3A through 3D illustrate transactions as directed links in a temporal graph, while FIG. 3E shows an exemplary sampled temporal random walk made by the multi-resolution temporal generative model 106. Aspects of the present disclosure can jointly utilize the extracted TRWs Wc and label information to infer the task-guided conditional probability distribution of temporal edges p(vᵢ, vⱼ, tᵢ | T) in the given financial transaction network G, where {vᵢ, vⱼ∈G, tᵢ} is a set of continuous timestamps, and T is the downstream task. By learning this distribution, it can be understood how a client vertex from class c interacts with other client vertices temporally and topologically, given the task T. However, directly approximating this distribution is challenging due to the correlation between (vᵢ, vⱼ, tᵢ). Aspects of the present disclosure can model the distribution of p(vᵢ, vⱼ, tᵢ | T) in a conditional generative manner. The method utilizes a temporal generator Ge with two decoders to separately decode a vertex vₜᵢ and continuous timestamp tᵢ. Additionally, a discriminator D_{θ} is used to evaluate a sequence of TRWs to identify whether they are true TRWs sampled from G or ones generated by the temporal generator Ge. The overall objective function of the multi-resolution temporal generative model 106 is defined as:

$${min}_{{G}_{θ}} {max}_{{D}_{θ}} {𝔼}_{{W}_{c} \sim pG ( {W}_{c} )} [ log {D}_{θ} ( {w}_{c} ) ] + {𝔼}_{{z}_{c} \sim pG ( {z}_{c} )} [ 1 - log {D}_{θ} ( {z}_{c} ) ] .$$

Given the objective function above, the multi-resolution temporal generative model 106 serves two goals: (1) learns topological and multi-resolution temporal properties from Wc, and (2) incorporates label information into the generation process. The multi-resolution temporal generative model 106 includes the following two components, a generator 108, 110 and a discriminator 112.

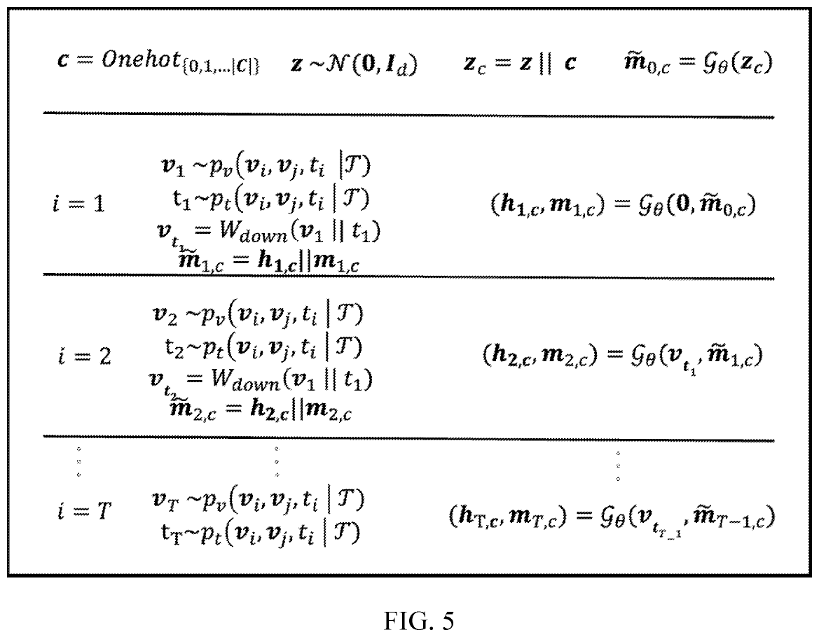

Generator. An aspect of the present disclosure is to generate TRW samples from class c to explicitly capture temporal and topological properties from class c. A latent vector is initialized as a multi-variant vector z∈N (0, I_{d}) which is a multi-variant normal distribution. A one-hot vector of class c is further concatenated with z to form the initial label-informed latent vector c_{c}. As shown in FIG. 1, in each long short-term memory (LSTM) cell 105, there are mainly two sub-modules: a vertex decoder 107 and a temporal decoder 109. The vertex decoder 107 decodes a client vertex with the highest probability from learned Ge and LSTM state h_{i,c}. The temporal decoder 109 decodes a timestamp from the current LSTM hidden state hᵢ following the temporal constraint (i.e., tₑᵢ≤tₑᵢ₊₁) and prior temporal distributions. Specifically, in each unique time step i, an LSTM cell 105 produces a cell state vector m_{i,c} and a hidden state vector h_{i,c} as input. The concatenated cell state is denoted as m_{i,c}. The detailed process is shown in FIG. 5, where ∥ denotes a concatenate operation.

Discriminator. The discriminator 112 uses a standard LSTM architecture. At each time step, a one-hot vertex representation vₜ and a temporal representation t are concatenated as input to the LSTM cells 113. After processing the entire sequence of T vertices, the discriminator 112 outputs a logit indicating the probability of the input TRW being sampled from G. With the Temporal Graph Generator, G_{θ}, and Discriminator, D_{θ}, the model learns the joint probability distribution of p(vᵢ, vⱼ, tᵢ | T) to characterize properties of G. This information is used in the financial transaction editor 114 to augment the financial transaction network through the financial transaction editor therein.

Financial Transaction Editor. In the multi-resolution temporal generative model 106, a multiresolution temporal generative model Ge was learned, which samples from a task-guided joint temporal edge probability distribution p(vᵢ, vⱼ, tᵢ | T). Aspects of the present disclosure provide an augmentation constraint to preserve most G's temporal and topological properties while fully capturing label information without “over-augmenting” (i.e., injecting extensive artificial biases) which may hurt the performance on a downstream task T. In particular, sampled W can be taken as a basis for augmentation, without perturbation from these artificial biases. To this goal, a general financial transaction editor 114 can include two graph editing operations {add, prune}.

The add operation is done in a three-step fashion. First, the joint probability distribution p(v₁, v₂, t₁) of candidate vertices can be decoded from the output of the vertex decoder and temporal decoder. At each time step, it is examined whether argmax (p(vᵢ | v₁, v₂, tᵢ) is over a pre-established add threshold ξ_{add}. As shown in FIG. 1, v_{argmax} and tᵢ are decoded from a temporal vertex decoder and a time decoder, respectively. For each instance, only one edge is added to avoid over-editing.

The prune operation is similar to the add operation, but instead of adding an edge to G, edges associated to the current vertex are pruned if p(vᵢ₋₁, vᵢ, tᵢ) is lower than the prune threshold ξₚᵣᵤₙₑ for the purpose of consistency.

In addition to Ge and De, a TRW editor discriminator 116 is introduced to prevent overediting if an edited sequence z is less likely preserving G's network properties. The output of the TRW editor discriminator 116 is an augmented financial transaction network 118, also referred to as augmented graph G.

### Experiments

Datasets. TGEditor, according to aspects of the present disclosure, was evaluated on real temporal graphs with vertex labels/edge labels, including variations of DBLP, SO, Chase, and Bitcoin. DBLP and SO are temporal collaboration networks, Chase is a temporal fraudulent transaction network, and Bitcoin is an anti-money laundering temporal transaction network.

Comparison Methods. TGEditor was compared with baseline models in two different aspects: (1) Temporal graph generative model adapted for data augmentation, and (2) traditional graph data augmentation methods. For (1), the baseline models were divided into two sets of models: Static graph generative models (i.e., Barabási Albert (BA)) and temporal graph generative models (TagGen and TGGAN). To uniformly compare methods on financial transaction networks and other temporal graphs, a well-known embedding method HTNE was used as a basis to process augmented graph G from the baseline methods and the methods of the present disclosure. Logistic regression was then used to evaluate the models' performances on the downstream tasks.

Evaluation Metrics. Performances were evaluated with baseline models in two aspects: (1) network properties, and (2) effectiveness on downstream tasks (vertex classification and fraud detection). For evaluating network properties, five widely-used network properties (i.e., MeanDegree, Number of components, LCC, Wedge Count, Claw Count) were considered for evaluation. They help illustrate how well a given model preserves the topological properties of a given financial transaction network. Given input financial transaction network G, the augmented network G and the evaluating metric \tilde{m}, each property f\tilde{m} (●) was measured as follows.

$$f \tilde{m} ( G , \tilde{G} , \tilde{m} ) = \vert ( \tilde{m} ( G ) - \tilde{m} ( \tilde{G} ) ) / \tilde{m} ( G ) \vert .$$

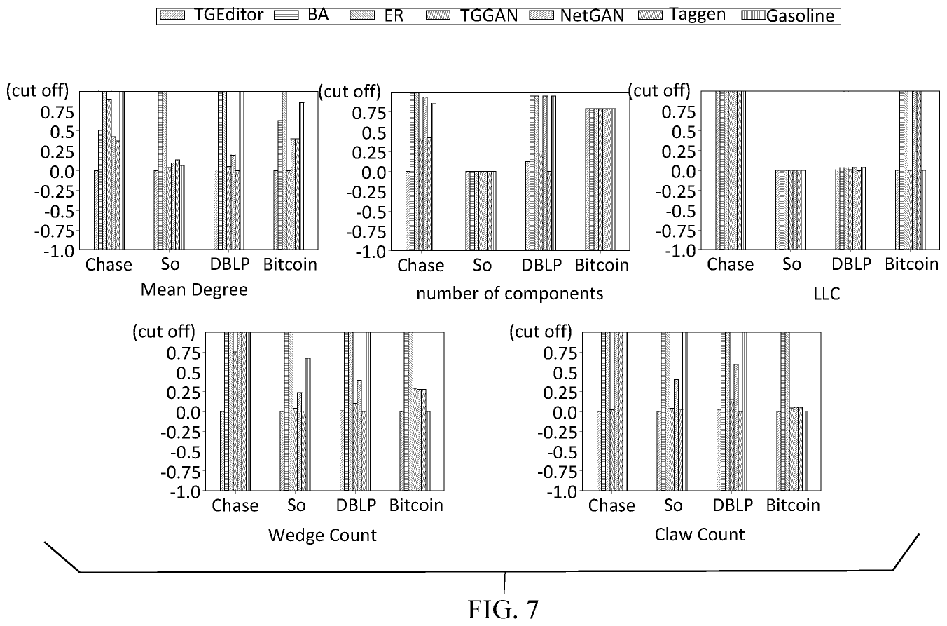

To evaluate models' effectiveness on downstream tasks, two standard evaluation metrics were considered to evaluate baseline models and methods of the present disclosure: Recall score for fraudulent transactions detection via edge classification and macro F1 accuracy score for the vertex classification task. All scores are average of multiple runs. FIG. 7 illustrates comparison results in preserving network properties with five baseline methods across four temporal graphs. All graphs are considered static. In all of the five graphs in FIG. 7, the performance that is the closer to the 0 is the better performance. For the sake of visualization, the graphs were scaled from −1 to 1 (cut-off) to visually compare baseline models and the model of the present disclosure. The bars in each graph are in order as shown in the key, where the model of the present disclosure (TGEditor) is always on the left side of each set of bars.

Quantitative Results in Preserving Network Properties. From the evaluation results, several interesting observations can be drawn from these results: (1) TGEditor outperforms the baseline methods across the five evaluation metrics and four datasets in most of the cases, (2) Two random graphs (i.e., BA and ER) generated \tilde{G}s have the worst performance. It was suspected that such random graph algorithms are often designed to model a certain structural distribution (e.g., n-component distribution) which leads to a lack of understanding of capturing many other network properties (e.g., LCC the largest connected component of the graph), and (3) Deep generative models (NetGAN, TGGAN, TagGen) have outperformed random graph generators and the graph augmentation model (GASOLINE) but are not comparable with TGEditor in most cases even though it shows competitive performance on classification tasks. It is suspected that the following reasons are why the TGEditor, according to aspects of the present disclosure, is better compared with other baseline models: (1) Task guidance from label-informed TRWs helps TGEditor framework preserve and understand topological properties, and (2) TGEditor framework's Dw prevents TGEditor framework from overediting G to minimally alters the topological properties.

Overall, from the observations, it was found that TGEditor accurately captures and preserves G's topological properties.

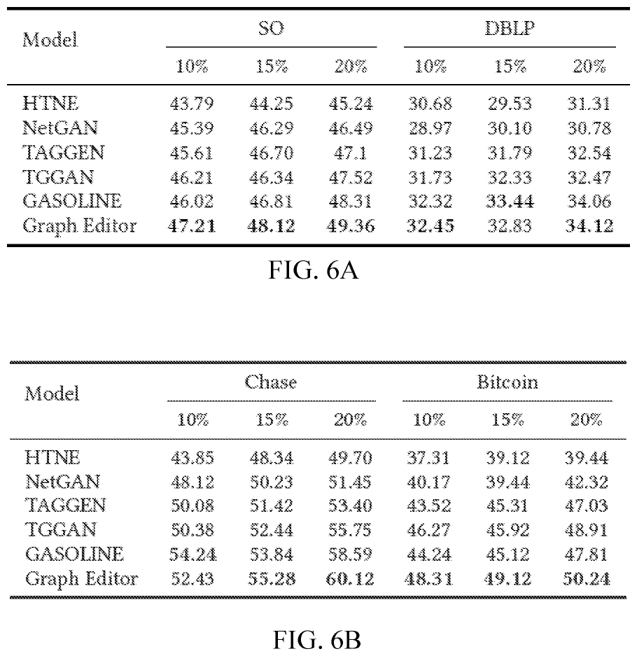

Quantitative Results in Data Augmentation. The TGEditor framework, according to aspects of the present disclosure, was compared with 6 baseline methods across 4 datasets on 2 evaluation downstream tasks: vertex classification and fraudulent transaction identification. The data set was split into training and test sets with the three sets of ratio: 10% training set: 90% test set, 15% training set: 85% test set, and 20% training set: 80% test set. Each experiment is repeated five times, and the average score was reported across four datasets in Table 1 and Table 2, illustrated in FIGS. 6A and 6B.

Vertex Classification. In this task, the SO and DBLP datasets were used for temporal collaboration graph classification. The goal is to predict vertex labels based on the model's understanding of temporal and topological context. Results in Table 1 (FIG. 6A) show that: (1) HTNE, a temporal graph embedding method, performs the worst due to its lack of deep understanding of topological and temporal attributes, (2) Deep generative models (NetGAN, TGGAN, TagGen) perform better than HTNE but underperform compared to the traditional graph data augmentation model (GASOLINE) and TGEditor. This is likely due to the fact that temporal collaboration networks are not sensitive to temporal attributes and topological properties are more important for classifying vertices, and (3) TGEditor outperforms other baseline models, demonstrating that task-guided label information can be a key factor in augmenting a temporal graph and improving performance on vertex classification tasks.

Fraudulent Transaction Identification. The detection of fraudulent transactions is an important problem for financial institutions. This task is challenging due to the time-sensitive and complex nature of the problem, as fraudulent transactions are often large in scale and the sparsity of financial transaction networks G presents a significant challenge for models to generalize effectively. A detailed comparison was demonstrated across different models in this task in Table 2 (FIG. 6B). In experiments, an MLP-based classification approach was employed to determine whether a given edge, e, in the network, represented by the concatenation of two vertex embeddings, v₁ and v₂, e=[v₁, v₂], is fraudulent or not, based on the encoded contextual information. Methods according to embodiments of the present disclosure, via the above described TGEditor, outperforms other methods, including GASOLINE and other deep generative models. This is attributed to the incorporation of task-guided label information, L, and multi-resolution properties in TGEditor, which addresses the challenges of sparsity in financial transaction networks. Furthermore, TGEditor preserves both topological and temporal properties of the original network, G, minimizing the potential injection of noisy information into the augmented network, G. Overall, the comparison experiments demonstrate that TGEditor effectively improves the generalization performance of the augmented financial transaction network G across all datasets.

### Example Process

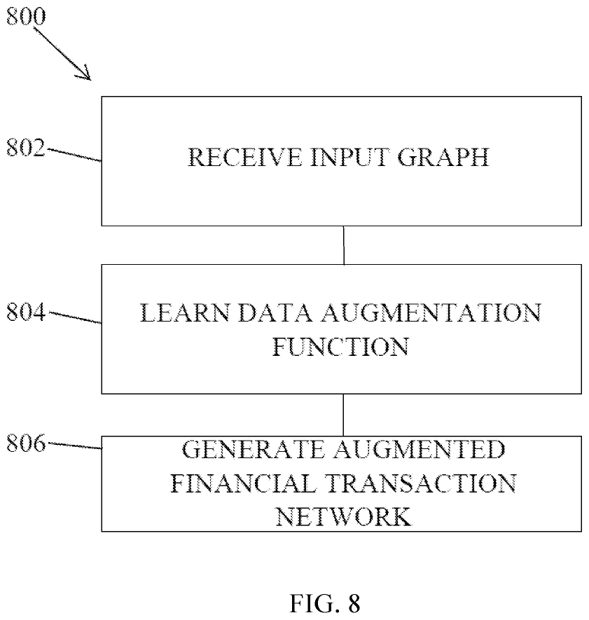

It may be helpful now to consider a high-level discussion of an example process. To that end, FIG. 8 presents an illustrative process 800 related to the method for task-guided graph augmentation and editing. Process 800 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 8, block 802 of process 800, can include an act of receiving an input graph in an observed financial transaction network. As described above, the input graph may be data sparse and/or noisy. At block 804, the process 800 can include an act of learning a data augmentation function that maintains a true data distribution of the input graph. The data augmentation function may be learned in the multi-resolution temporal generative model, as described above. Finally, at block 804, the process 800 can include generating an augmented financial transaction network that enhances performance of a downstream task and preserves topological and temporal properties of the input graph.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

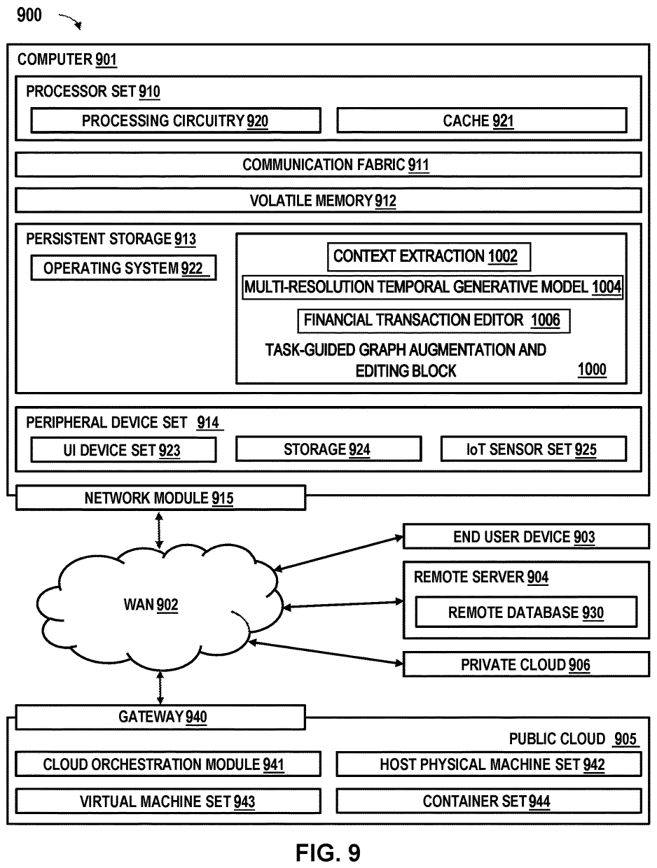

Referring to FIG. 9, computing environment 900 includes an example of an environment for the execution of at least some of the computer code involved in performing the inventive methods, including a task-guided graph augmentation and editing block 1000, which can include a context extractor block 1002, a multi-resolution temporal generative model block 1004 and a financial transaction editor block 1006. In addition to block 1000, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 1000, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 1000 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 1000 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for task-guided graph augmentation and editing, comprising:
receiving an input graph in an observed financial transaction network;
learning a data augmentation function that maintains a true data distribution of the input graph; and
generating an augmented financial transaction network that enhances performance of a downstream task and preserves topological and temporal properties of the input graph.

2. The method of claim 1, further comprising determining, via adversarial training, an add operator operable to add additional links to the input graph.

3. The method of claim 1, further comprising determining, via adversarial training, a prune operator operable to remove selected links from the input graph.

4. The method of claim 1, further comprising extracting network contextual information from the input graph with a task-guided context extractor by sampling a set of temporal random walk sequences conditioned on a specific task.

5. The method of claim 4, further comprising learning and inferring, from multi-resolution temporal properties and topological properties of the input graph, to generate a multi-resolution temporal generative model for generating the data augmentation function.

6. The method of claim 5, further comprising training the multi-resolution temporal generative model with the set of temporal random walk sequences generated by the task-guided context extractor.

7. The method of claim 5, wherein the multi-resolution temporal generative model includes a generator operable to generate temporal random walk samples from a given class to explicitly capture temporal and topological properties from the given class.

8. The method of claim 7, wherein the multi-resolution temporal generative model includes a discriminator operable to output a logit indicating a probability of generated temporal random walk samples being sampled from the input graph.

9. The method of claim 5, further comprising preventing overediting by removing an edited sequence from the augmented financial transaction network if the edited sequence does not preserve network properties of the input graph.

10. A system comprising:
a processor;
a data bus coupled to the processor;
a memory coupled to the data bus; and
a computer-usable medium embodying a computer program code, the computer program code comprising instructions executable by the processor and configured to:
receive an input graph in an observed financial transaction network;
learn a data augmentation function that maintains a true data distribution of the input graph; and
generate an augmented financial transaction network that enhances performance of a downstream task and preserves topological and temporal properties of the input graph.

11. The system of claim 10, wherein the instructions are further configured to:
determine, via adversarial training, an add operator operable to add additional links to the input graph; and
determine, via adversarial training, a prune operator operable to remove selected links from the input graph.

12. The system of claim 10, wherein the instructions are further configured to extract network contextual information from the input graph with a task-guided context extractor by sampling a set of temporal random walk sequences conditioned on a specific task.

13. The system of claim 12, wherein the instructions are further configured to generate a multi-resolution temporal generative model, for generating the data augmentation function, by learning and inferring from multi-resolution temporal properties and topological properties of the input graph.

14. The system of claim 13, training the multi-resolution temporal generative model with the set of temporal random walk sequences generated by the task-guided context extractor.

15. The system of claim 13, wherein the multi-resolution temporal generative model includes a generator operable to generate temporal random walk samples from a given class to explicitly capture temporal and topological properties from the given class.

16. The system of claim 13, wherein the multi-resolution temporal generative model includes a discriminator operable to output a logit indicating a probability of generated temporal random walk samples being sampled from the input graph.

17. A computer program product for task-guided graph augmentation and editing, the computer program product comprising a computer readable storage medium having program instructions embodied therewith, the program instructions executable by a computer to cause the computer to:
receive an input graph in an observed financial transaction network;
learn a data augmentation function that maintains a true data distribution of the input graph; and
generate an augmented financial transaction network that enhances performance of a downstream task and preserves topological and temporal properties of the input graph.

18. The computer program product of claim 17, wherein the instructions are further configured to:
determine, via adversarial training, an add operator operable to add additional links to the input graph; and
determine, via adversarial training, a prune operator operable to remove selected links from the input graph.

19. The computer program product of claim 17, wherein the instructions are further configured to:
extract network contextual information from the input graph with a task-guided context extractor by sampling a set of temporal random walk sequences conditioned on a specific task and
generate a multi-resolution temporal generative model, for generating the data augmentation function, by learning and inferring from multi-resolution temporal properties and topological properties of the input graph.

20. The computer program product of claim 19, wherein the multi-resolution temporal generative model includes a generator, operable to generate temporal random walk samples from a given class to explicitly capture temporal and topological properties from the given class, and a discriminator, operable to output a logit indicating a probability of generated temporal random walk samples being sampled from the input graph.
